(19) United States
(12) Patent Application Publication
(10) Pub. No.: US 2024/0392091 A1
(43) Pub. Date: Nov. 28, 2024

(54) Method and Device for Recycling and Granulating PP Composite Medical Drip Soft Bags

(71) Applicant: Green Hung Enterprise Co., Ltd., Taichung City (TW)

(72) Inventor: Ming Chien Hsieh, Taichung City (TW)

(21) Appl. No.: 18/671,199

(22) Filed: May 22, 2024

(30) Foreign Application Priority Data
May 25, 2023 (TW) 112119585

(51) Int. Cl. C08J 11/06; B29B 9/16; B29B 17/02; B29B 17/04; B29K 23/00; B29L 31/00

(52) U.S. Cl. CPC C08J 11/06; B29B 9/16; B29B 17/02; B29B 17/0412; B29B 2017/0203; B29B 2017/0227; B29B 2017/046; B29K 2023/12; B29L 2031/7148; C08J 2323/12

(57) ABSTRACT

Provided are a method and a device for recycling and granulating PP composite medical drip soft bags. The method includes: putting a fragment mixture of a recycled PP composite medical drip soft bag into a hopper; heating the fragment mixture to a predetermined temperature for kneading, filtering the heated fragment mixture, and then extruding the heated fragment mixture after filtering; cooling the fragment mixture; shaping and granulating the fragment mixture to form a plurality of particle materials; cleaning the particle materials; dehydrating the particle materials; vibration screening the particle materials according to different sizes; and outputting the particle materials with respective sizes to different storage barrels. This is used to recycle PP composite medical drip soft bags to achieve the effects of recycling, improving processing efficiency and creating friendly environment.

### CROSS-REFERENCE TO RELATED APPLICATION

This application claims the priority of Taiwanese patent application No. 112119585, filed on May 25, 2023, which is incorporated herewith by reference.

### BACKGROUND OF THE INVENTION

### 1. Field of the Invention

The present invention relates to a recycling technology field, in particular to a method and a device for recycling and granulating PP composite medical drip soft bags.

### 2. Prior Art

At present, used PP (Polypropylene) composite medical drip soft bags (such as intravenous drip bags) cannot be completely recycled, and they are all burned. During its burning process, it is easy to produce harmful gases or substances such as dioxin, which not only consumes fuel and cost, but also easily pollutes the environment.

### SUMMARY OF THE INVENTION

A primary objective of the present invention is to provide a method and a device for recycling and granulating PP composite medical drip soft bags. The recycled PP composite medical drip soft bags are crushed by a crushing unit. After cleaning and dehydration, they are evenly stirred with a co-solvent to form a fragment mixture with PP materials. Then through heating and kneading, filtering and extruding, cooling, shaping and granulating, cleaning, dehydrating, vibration screening and outputting to storage barrels according to different sizes to complete the recycling and granulation of PP composite medical drip soft bags. This is used to recycle PP composite medical drip soft bags to achieve the effects of recycling, improving processing efficiency and creating friendly environment.

A method for recycling and granulating PP composite medical drip soft bags includes putting a fragment mixture of a recycled PP composite medical drip soft bag into a hopper; heating the fragment mixture to a predetermined temperature for kneading, filtering the heated fragment mixture, and then extruding the heated fragment mixture after filtering; cooling the fragment mixture; shaping and granulating the fragment mixture to form a plurality of particle materials; cleaning the particle materials; dehydrating the particle materials; vibration screening the particle materials according to different sizes; and outputting the particle materials with respective sizes to different storage barrels.

In some embodiments, before the step of putting a fragment mixture of a recycled PP composite medical drip soft bag into a hopper, the method further comprises manually sorting the recycled PP composite medical drip soft bags to pick out PP composite materials, crushing the PP composite materials, cleaning a plurality of fragments of the crushed PP composite materials, and resorting the fragments, dehydrating the fragments and packing the fragments into space packages.

In some embodiments, before the step of putting a fragment mixture of a recycled PP composite medical drip soft bag into a hopper, the method further comprises drying the fragments and evenly stirring the fragments with a co-solvent to form the fragment mixture.

In some embodiments, the predetermined temperature is between 150° C. and 300° C.

In some embodiments, the step of shaping and granulating the fragment mixture to form a plurality of particle materials is to use water for cooling for shaping and granulating, so that the viscosity and particle size of the particle materials are in an optimal state.

A device for recycling and granulating PP composite medical drip soft bags includes a hopper, receiving a fragment mixture of a recycled PP composite medical drip soft bag; a heating and kneading unit, connected to the hopper, receiving the fragment mixture from the hopper and heating and kneading the fragment mixture to a predetermined temperature and then advancing; a first die, connected to the heating and kneading unit to filter and extrude the fragment mixture after heating and kneading; a cooling unit, connected to the first die to cool and advance the extruded fragment mixture; a second die, connected to the cooling unit for shaping and granulating the cooled fragment mixture to form a plurality of particle materials; a water channel, connected to the second die to transport and clean the particle materials; a dehydrator, connected to the water channel to dehydrate and transport the cleaned particle materials; a vibration screening unit, connected to the dehydrator and vibrating to screen the particle materials according to different sizes; and a plurality of storage barrels, arranged adjacent to the vibration screening unit to collect the particle materials with respective sizes.

In some embodiments, the device further comprises a crushing unit, crushing PP composite materials picked out from the recycled PP composite medical drip soft bag to form a plurality of fragments, wherein the fragments are evenly stirred with a co-solvent to form the fragment mixture.

In some embodiments, the heating and kneading unit and the cooling unit have a screw structure.

In some embodiments, the predetermined temperature is between 150° C. and 300° C.

In some embodiments, the first die head is provided with a filter plate.

In order to make the above objectives, features and advantages of the present invention more obvious and understandable, the specific embodiments listed in the drawings are described in detail below.

### BRIEF DESCRIPTION OF DRAWINGS

Aspects of the present invention are best understood from the following detailed description when read with the accompanying drawings. It is noted that, in accordance with the standard practice in the industry, various features are not drawn to scale. In fact, the dimensions of the various features may be increased or reduced for clarity of discussion.

FIG. 1 is a schematic diagram of a device for recycling and granulating PP composite medical drip soft bags according to the present invention.

FIG. 2 is a partial diagram of a device for recycling and granulating PP composite medical drip soft bags according to the present invention.

FIG. 3 is a partial diagram of a device for recycling and granulating PP composite medical drip soft bags according to the present invention.

FIG. 4 is a partial diagram of a device for recycling and granulating PP composite medical drip soft bags according to the present invention.

FIG. 5 is a partial diagram of a device for recycling and granulating PP composite medical drip soft bags according to the present invention.

FIG. 6 is an operation diagram of the device for recycling and granulating PP composite medical drip soft bags according to the present invention.

FIG. 7 is a flow chart of a method for recycling and granulating PP composite medical drip soft bags according to the present invention.

### DETAILED DESCRIPTION OF THE INVENTION

It will be appreciated that, although specific embodiments of the present invention are described herein for purposes of illustration, various modifications may be made without departing from the spirit and scope of the present invention.

In the following description, certain specific details are set forth in order to provide a thorough understanding of various aspects of the disclosed subject matter. However, the disclosed subject matter may be practiced without these specific details. In some instances, well-known structures and methods of power delivery comprising embodiments of the subject matter disclosed herein have not been described in detail to avoid obscuring the descriptions of other aspects of the present invention.

Unless the context requires otherwise, throughout the specification and claims that follow, the word “comprise,” “have,” “include,” and variations thereof, such as “comprises,” “comprising,” “having,” “including” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present invention.

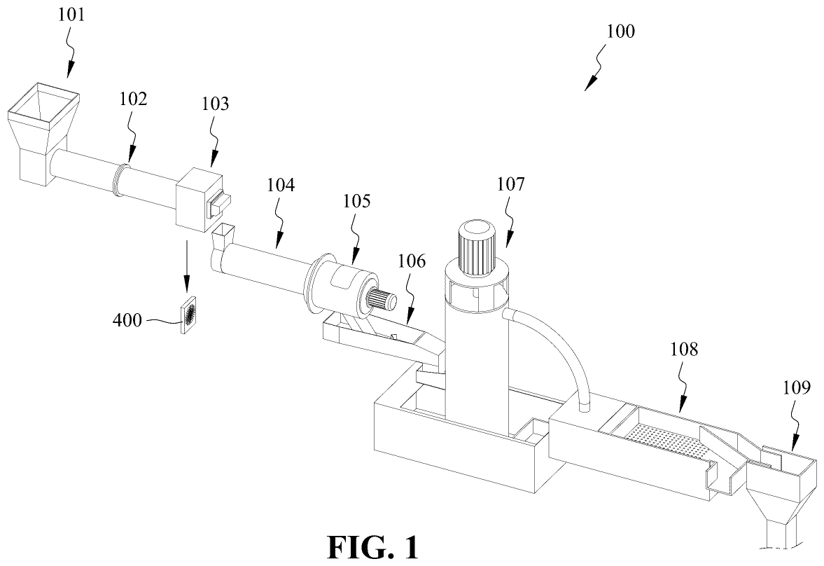

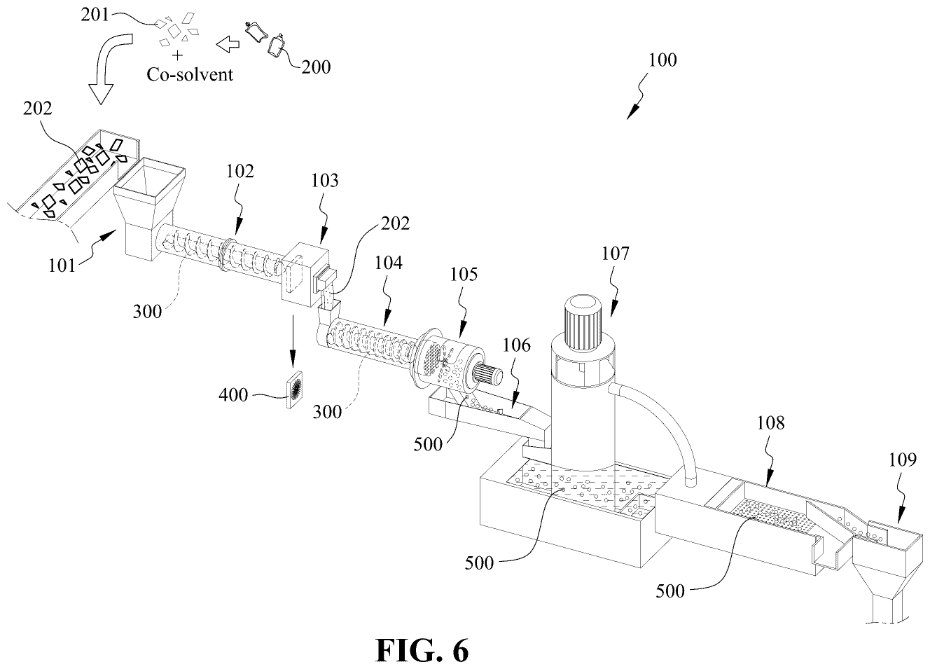

FIG. 1 is a schematic diagram of a device for recycling and granulating PP composite medical drip soft bags according to the present invention. FIG. 6 is an operation diagram of the device for recycling and granulating PP composite medical drip soft bags according to the present invention. Please refer to FIG. 1 and FIG. 6, the device 100 for recycling and granulating PP composite medical drip soft bags of the present invention includes a hopper 101, a heating and kneading unit 102, a first die 103, a cooling unit 104, a second die 105, a water channel 106, a dehydrator 107, a vibration screening unit 108 and a plurality of storage barrels 109.

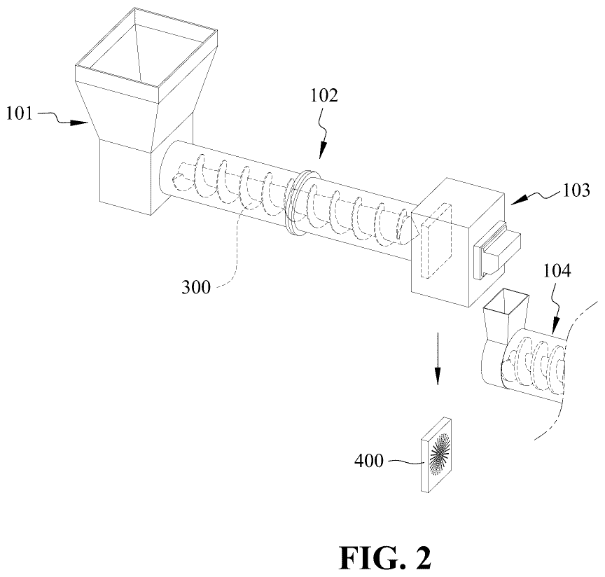

FIG. 2 is a partial diagram of a device for recycling and granulating PP composite medical drip soft bags according to the present invention. Please refer to FIG. 2 and FIG. 1, the hopper 101 is used to receive a fragment mixture 202 of a recycled PP composite medical drip soft bag 200. In some embodiments, the device 100 for recycling and granulating PP composite medical drip soft bags of the present invention further includes a crushing unit (not shown) for crushing the PP composite material picked out from the recycled PP composite medical drip soft bag 200 to form a plurality of fragments 201. The fragments 201 are evenly stirred with a co-solvent to form a fragment mixture 202.

The heating and kneading unit 102 is connected to and communicated with the hopper 101 for receiving the fragment mixture 202 from the hopper 101 and heating and kneading the fragment mixture 202 to a predetermined temperature and then advancing. In some embodiments, the predetermined temperature is between 150° C. and 300° C. In some embodiments, the heating and kneading unit 102 has a screw structure 300 for uniformly heating the fragment mixture 202 and advancing the fragment mixture 202 into the first die 103.

The first die 103 is connected to the heating and kneading unit 102 to filter and extrude the fragment mixture 202 after heating and kneading; wherein, the extruded fragment mixture 202 is similar to dough. In some embodiments, as shown in FIG. 2, the first die 103 is provided with a filter plate 400 for filtering the fragment mixture 202 after heating and kneading.

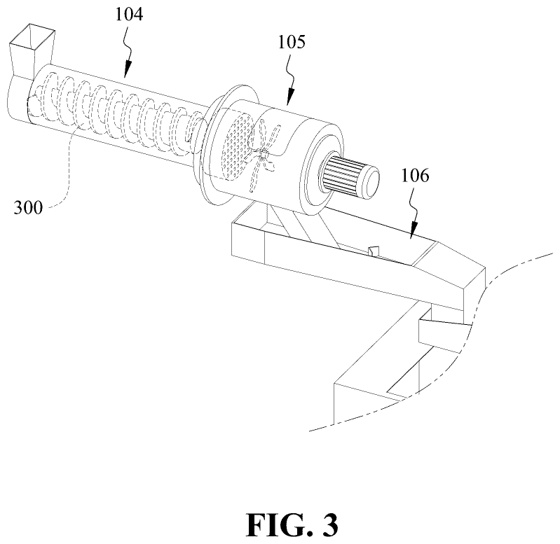

FIG. 3 is a partial diagram of a device for recycling and granulating PP composite medical drip soft bags according to the present invention. Please refer to FIG. 3 and FIG. 1, the cooling unit 104 is connected to the first die 103 to cool and advance the extruded fragment mixture 202. In some embodiments, the cooling unit 104 has a screw structure 300 for uniformly cooling the fragment mixture 202 and advancing the fragment mixture 202 to the second die 105. The screw structure of the cooling unit 104 is similar to or the same as the screw structure 300 of the heating and kneading unit 102, and is therefore represented by the same numeral.

The second die 105 is connected to the cooling unit 104 for shaping and granulating the cooled fragment mixture 202 to form a plurality of particle materials 500, such as particles.

The water channel 106 is connected to the second die 105 to transport and clean the particle materials 500. In some embodiments, the particle materials 500 are transported to the dehydrator 107 via the water channel 106.

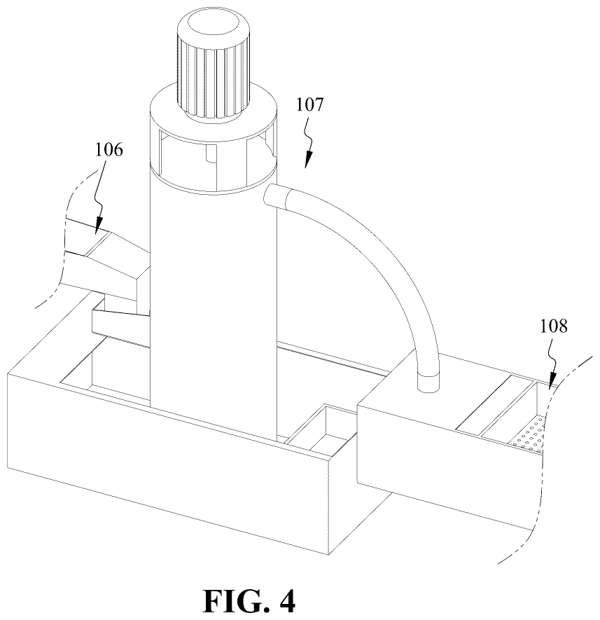

FIG. 4 is a partial diagram of a device for recycling and granulating PP composite medical drip soft bags according to the present invention. Please refer to FIG. 4 and FIG. 1, the dehydrator 107 is connected to the water channel 106 to dehydrate and transport the cleaned particle materials 500. In some embodiments, the particle materials 500 are transported to the vibrating screening unit 108 by the dehydrator 107.

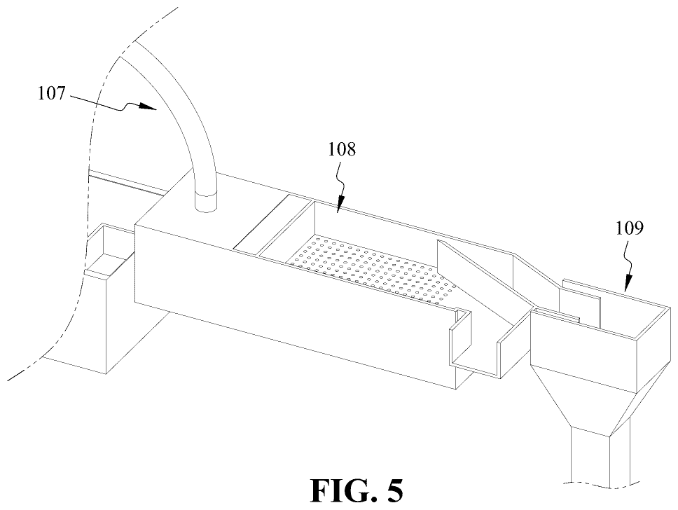

FIG. 5 is a partial diagram of a device for recycling and granulating PP composite medical drip soft bags according to the present invention. Please refer to FIG. 5 and FIG. 1, the vibration screening unit 108 is connected to the dehydrator 107 for vibrating to screen the particle materials 500 according to different sizes.

The storage barrels 109 are arranged adjacent to the vibration screening unit 108 to collect the particle materials 500 with respective sizes.

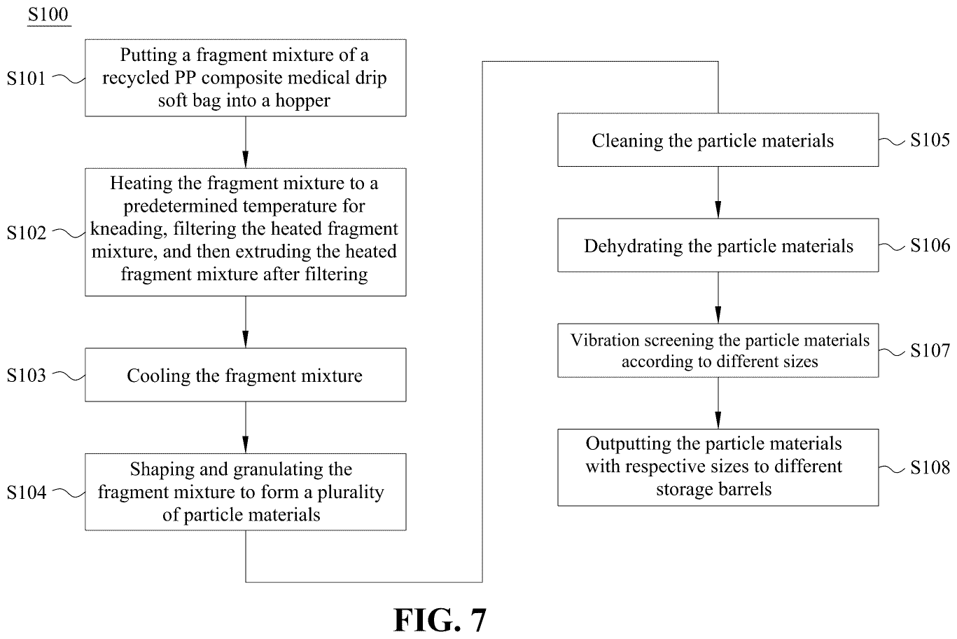

FIG. 7 is a flow chart of a method for recycling and granulating PP composite medical drip soft bags according to the present invention. Please refer to FIG. 7, the method S100 for recycling and granulating PP composite medical drip soft bags of the present invention includes: putting a fragment mixture of a recycled PP composite medical drip soft bag into a hopper (e.g., step S101); heating the fragment mixture to a predetermined temperature for kneading, filtering the heated fragment mixture, and then extruding the heated fragment mixture after filtering (e.g., step S102); cooling the fragment mixture (e.g., step S103); shaping and granulating the fragment mixture to form a plurality of particle materials (e.g., step S104); cleaning the particle materials (e.g., step S105); dehydrating the particle materials (e.g., step S106); vibration screening the particle materials according to different sizes (e.g., step S107); and outputting the particle materials with respective sizes to different storage barrels (e.g., step S108).

Please refer to FIG. 1 to FIG. 7, step S101 is implemented by the hopper 101; step S102 is implemented by the heating and kneading unit 102 and the first die head 103; step S103 is implemented by the cooling unit 104; step S104 is implemented by the second die 105; step S105 is implemented by the water channel 106; step S106 is implemented by the dehydrator 107; step S107 is implemented by the vibration screening unit 108; and step S108 is implemented by the storage barrels 109.

In some embodiments, before the step (e.g., step S101) of putting a fragment mixture of a recycled PP composite medical drip soft bag into a hopper, the method S100 further includes: manually sorting the recycled PP composite medical drip soft bags 200 to pick out PP composite materials, crushing the PP composite materials, cleaning a plurality of fragments 201 of the crushed PP composite materials, and resorting the fragments 201, dehydrating the fragments 201 and packing the fragments 201 into space packages. This can be implemented by a crushing unit (not shown). In some embodiments, before the step (e.g., step S101) of putting a fragment mixture of a recycled PP composite medical drip soft bag into a hopper, the method further includes: drying the fragments 201 and evenly stirring the fragments 201 with a co-solvent to form the fragment mixture 202.

In some embodiments, the predetermined temperature in step S102 is between 150° C. and 300° C.

The step (e.g., step S104) of shaping and granulating the fragment mixture to form a plurality of particle materials is to use water for cooling for shaping and granulating, so that the viscosity and particle size of the particle materials 500 are in an optimal state.

In summary, the recycled PP composite medical drip soft bags 200 are crushed by the crushing unit (not shown). After cleaning and dehydration, they are evenly stirred with a co-solvent to form the fragment mixture 202 with PP materials. Then through heating and kneading, filtering and extruding, cooling, shaping and granulating, cleaning, dehydrating, vibration screening and outputting to the storage barrels 109 according to different sizes to complete the recycling and granulation of PP composite medical drip soft bags 200. This is used to recycle PP composite medical drip soft bags 200 to achieve the effects of recycling, improving processing efficiency and creating friendly environment.

What is claimed is:

1. A method for recycling and granulating PP composite medical drip soft bags, comprising:
putting a fragment mixture of a recycled PP composite medical drip soft bag into a hopper;
heating the fragment mixture to a predetermined temperature for kneading, filtering the heated fragment mixture, and then extruding the heated fragment mixture after filtering;
cooling the fragment mixture;
shaping and granulating the fragment mixture to form a plurality of particle materials;
cleaning the particle materials;
dehydrating the particle materials;
vibration screening the particle materials according to different sizes; and
outputting the particle materials with respective sizes to different storage barrels.

2. The method according to claim 1, wherein before the step of putting the fragment mixture of the recycled PP composite medical drip soft bag into the hopper, the method further comprises manually sorting the recycled PP composite medical drip soft bags to pick out PP composite materials, crushing the PP composite materials, cleaning a plurality of fragments of the crushed PP composite materials, and resorting the fragments, dehydrating the fragments and packing the fragments into space packages.

3. The method according to claim 2, wherein before the step of putting the fragment mixture of the recycled PP composite medical drip soft bag into the hopper, the method further comprises drying the fragments and evenly stirring the fragments with a co-solvent to form the fragment mixture.

4. The method according to claim 1, wherein the predetermined temperature is between 150° C. and 300° C.

5. The method according to claim 1, wherein the step of shaping and granulating the fragment mixture to form the plurality of particle materials is to use water for cooling for shaping and granulating, so that a viscosity and a particle size of the particle materials are in an optimal state.

6. A device for recycling and granulating PP composite medical drip soft bags, comprising:
a hopper, receiving a fragment mixture of a recycled PP composite medical drip soft bag;
a heating and kneading unit, connected to the hopper, receiving the fragment mixture from the hopper and heating and kneading the fragment mixture to a predetermined temperature and then advancing;
a first die, connected to the heating and kneading unit to filter and extrude the fragment mixture after heating and kneading;
a cooling unit, connected to the first die to cool and advance the extruded fragment mixture;
a second die, connected to the cooling unit for shaping and granulating the cooled fragment mixture to form a plurality of particle materials;
a water channel, connected to the second die to transport and clean the particle materials;
a dehydrator, connected to the water channel to dehydrate and transport the cleaned particle materials;
a vibration screening unit, connected to the dehydrator and vibrating to screen the particle materials according to different sizes; and
a plurality of storage barrels, arranged adjacent to the vibration screening unit to collect the particle materials with respective sizes.

7. The device according to claim 6, further comprising a crushing unit, crushing PP composite materials picked out from the recycled PP composite medical drip soft bag to form a plurality of fragments, wherein the fragments are evenly stirred with a co-solvent to form the fragment mixture.

8. The device according to claim 6, wherein the heating and kneading unit and the cooling unit have a screw structure.

9. The device according to claim 6, wherein the predetermined temperature is between 150° C. and 300° C.

10. The device according to claim 6, wherein the first die head is provided with a filter plate.
